(19) United States
(12) Patent Application Publication
(10) Pub. No.: US 2022/0238882 A1
(43) Pub. Date: Jul. 28, 2022

(54) TRAGACANTH GUM (TGC)-BASED AQUEOUS BINDER AND METHOD FOR MANUFACTURING BATTERY ELECTRODE USING SAME

(71) Applicant: UNIVERSITY-INDUSTRY COOPERATION GROUP OF KYUNG HEE UNIVERSITY, Yongin-si (KR)

(72) Inventors: Chang Woo LEE, Hwaseong-si (KR); Jae Woo PARK, Jeonju-si (KR)

(73) Assignee: UNIVERSITY-INDUSTRY COOPERATION GROUP OF KYUNG HEE UNIVERSITY, Yongin-si (KR)

(21) Appl. No.: 17/543,109

(22) Filed: Dec. 6, 2021

(30) Foreign Application Priority Data
Jan. 25, 2021 (KR) 10-2021-0010120

(51) Int. Cl. H01M 4/62; H01M 4/525; H01M 4/36; H01M 4/04; H01M 4/1391; H01M 10/0525

(52) U.S. Cl. CPC H01M 4/622; H01M 4/525; H01M 4/366; H01M 10/0525; H01M 4/626; H01M 4/0404; H01M 4/1391; H01M 4/625

(57) ABSTRACT

The present disclosure relates to an aqueous binder for a battery electrode, composed of tragacanth gum (TGC), an active material slurry composition for a battery electrode, including the aqueous binder, a battery electrode including the aqueous binder, and a lithium-ion battery including the battery electrode. The aqueous binder for the battery electrode, composed of tragacanth gum, according to the present disclosure may provide a battery electrode which is manufactured by an environmentally friendly and economical method by enabling environmentally friendly water (H₂O) to be used as a solvent instead of a conventional non-aqueous solvent which is expensive and harmful to the environment. Furthermore, a battery manufactured using the aqueous binder composed of tragacanth gum, for example, a lithium-ion battery has an effect that it can provide improved electrochemical properties compared to a lithium-ion battery manufactured using a conventional PVdF-based binder.

### CROSS-REFERENCE TO RELATED APPLICATIONS

This application is based on and claims priority from Korean Patent Application No. 10-2021-0010120, filed on Jan. 25, 2021, with the Korean Intellectual Property Office, the disclosure of which is incorporated herein in its entirety by reference.

### TECHNICAL FIELD

The present disclosure relates to an aqueous binder for a battery electrode, composed of tragacanth gum (TGC), an active material slurry composition for a battery electrode, including the aqueous binder, a battery electrode manufactured using the active material slurry composition, and a lithium-ion battery including the battery electrode.

### BACKGROUND

Due to a rapid increase in the use of fossil fuels, the demand for the use of alternative energy or clean energy is increasing, and the field of electrochemical devices using electrochemical energy is actively being studied due to such a demand. A typical example of the electrochemical devices is a secondary battery, and its use area is gradually expanding.

A lithium secondary battery, which is the most advanced type of secondary battery, refers to a battery in which lithium ions participate in a redox reaction in an anode. Lithium is the lightest alkali metal existing on earth with a density of 0.53 g/cm³ and an element having the lowest standard redox potential. Due to such unique characteristics of lithium, many studies have been conducted to use it as an anode of the battery, and in particular, lithium-ion batteries (LIBs) are receiving great attention from battery application fields of high energy density applications such as electric vehicles and hybrid electric vehicles due to their high energy density, long lifespan and wide potential.

Meanwhile, a binder in the manufacture of the electrode of the battery refers to a material playing a role of helping the active material layer so that an active material layer containing an electrode active material and a conductive material adheres to a current collector of the electrode composed of metal, etc. The binder should maintain stable adhesive properties without side reactions even in a chemical environment in which it is in contact with an electrolyte within the battery and in an electrochemical environment in which harsh oxidation/reduction reactions occur.

Particularly recently, the role of the binder is becoming more and more important as it is necessary to secure long-term reliability in mid- to large-sized batteries in which thickness and density of the active material layer are continuously increased in order to improve the energy density of the battery, and which must be driven for 10 years or more in high-temperature and low-temperature environments.

Currently, although polyvinylidene fluoride (PVdF)-based binders which have excellent solubility in solvents, and are excellent in chemical resistance and electrochemical resistance in a battery use environment are well known as the most common binder for a battery electrode, the PVdF-based binders are expensive, N-methyl-2-pyrrolidone (NMP), a very toxic organic solvent, must be used as a solvent, and there are an environmental problem and a problem of unit price increase.

The current situation is that although various studies for the development of an aqueous binder using water as a solvent instead of the organic solvent are being conducted, the development of an aqueous binder exhibiting electrochemical properties similar to those of a battery manufactured using the PVdF-based binders has not been reached.

It is necessary to develop a new eco-friendly aqueous binder for a battery electrode, that uses water, which is harmless to the environment, as a solvent while simultaneously satisfying high capacity and high safety of batteries.

### PRIOR ART DOCUMENT

[Patent Document]

(Patent document 1) Korean Patent No. 10-1320381

### SUMMARY

The present disclosure has been made in an effort to provide an aqueous binder for a battery electrode, composed of tragacanth gum.

Further, the present disclosure has been made in an effort to provide an active material slurry composition for a battery electrode, including the aqueous binder.

Further, the present disclosure has been made in an effort to provide a method for manufacturing a battery electrode using the active material slurry composition.

Further, the present disclosure has been made in an effort to provide a battery electrode including the aqueous binder and a lithium-ion battery including the battery electrode.

In order to achieve the above-described objects,

an exemplary embodiment of the present disclosure provides an aqueous binder for a battery electrode, composed of tragacanth gum (TGC).

Another exemplary embodiment of the present disclosure provides an active material slurry composition for a battery electrode, including: an electrode active material; an aqueous binder composed of tragacanth gum (TGC); and a solvent composed of water (H₂O).

Yet another exemplary embodiment of the present disclosure provides a method for manufacturing a battery electrode, the method including the steps of: preparing an active material slurry composition by mixing an electrode active material, an aqueous binder composed of tragacanth gum (TGC), and water (H₂O) (step 1); and forming an active material layer by applying the active material slurry composition to the surface of a current collector and drying the active material slurry composition (step 2).

Yet another exemplary embodiment of the present disclosure provides a battery electrode including the aqueous binder.

Yet another exemplary embodiment of the present disclosure provides a lithium-ion battery including the battery electrode.

According to the exemplary embodiments of the present disclosure, the aqueous binder for the battery electrode, composed of tragacanth gum, according to the present disclosure, may provide a battery electrode which is manufactured by an environmentally friendly and economical method by enabling environmentally friendly water (H₂O) to be used as a solvent instead of a conventional non-aqueous solvent which is expensive and harmful to the environment.

Furthermore, a battery manufactured using the aqueous binder composed of tragacanth gum, for example, a lithium-ion battery has an effect that it can provide a lithium-ion battery which is sufficient to replace a lithium-ion battery manufactured using a conventional PVdF-based binder.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1A to 1C are XRD pattern results of examples and comparative examples of the present disclosure.

FIGS. 2A to 2C are graphs showing viscosities of the active material slurry compositions depending on the shear rates of examples and comparative examples of the present disclosure.

FIG. 3A is a schematic diagram showing interactions of a binder, a cathode active material, and a conductive material on the surface of a lithium-ion battery cathode, and FIGS. 3B to 3G are FE-SEM images of the surfaces of the lithium-ion battery cathodes of examples and comparative examples of the present disclosure.

FIGS. 4A and 4B are charge/discharge profiles of an example and a comparative example of the present disclosure.

FIG. 5A is a graph showing the lifespan characteristics of the lithium-ion battery cathodes of an example and a comparative example of the present disclosure, and FIG. 5B is a graph showing rate performances.

FIGS. 6A and 6B are graphs showing differential capacity profiles of the lithium-ion battery cathodes of an example and a comparative example of the present disclosure.

FIGS. 7A and 7B are charge/discharge profiles of an example and a comparative example of the present disclosure.

FIG. 8A is a graph showing the lifespan characteristics of the lithium-ion battery cathodes of an example and a comparative example of the present disclosure and FIG. 8B is a graph showing rate performances.

FIGS. 9A and 9B are graphs showing differential capacity profiles of the lithium-ion battery cathodes of an example and a comparative example of the present disclosure.

FIGS. 10A and 10B are charge/discharge profiles of an example and a comparative example of the present disclosure.

FIG. 11A is a graph showing the lifespan characteristics of the lithium-ion battery cathodes of an example and a comparative example of the present disclosure, and FIG. 11B is a graph showing rate performances.

FIGS. 12A and 12B are graphs showing differential capacity profiles of the lithium-ion battery cathodes of an example and a comparative example of the present disclosure.

FIG. 13A is a diagram showing a Randles equivalent circuit, and FIGS. 13B to 13D are Nyquist plots for the lithium-ion batteries of examples and comparative examples of the present disclosure.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

Hereinafter, the present disclosure will be described in detail.

An aspect of the present disclosure provides an aqueous binder for a battery electrode, composed of tragacanth gum (TGC).

In the present specification, tragacanth gum (TGC), as a polysaccharide obtained by drying the secretion liquid secreted from the stem wound of legume Astragalus gummifer Labill. or allied plants, is a plant-based natural polymer.

TGC is mainly composed of a complex mixture of water-soluble acidic branched heteropolysaccharides containing D-galacturonic acid, it contains D-galactose, L-fucose (6-deoxy-1-galactose), β-D-xylose, and L-arabinose after hydrolysis, and insoluble Bassorin contains D-galacturonic acid methyl ester instead of the acid unit.

The above-described natural polymer, TGC, can be used as food packaging, water treatment, drug carrier, and the like due to its abundant, low cost, and environmentally friendly characteristics, and has recently been used in the food industry, pharmaceutical industry, biomedical field, etc.

The present disclosure has been derived to overcome problems that the manufacturing cost is high and the conventional non-aqueous binder is harmful to the environment when manufacturing a battery electrode using a conventional non-aqueous binder, and a problem that competitiveness is not secured since the electrochemical activity is lower than that of a battery manufactured using the non-aqueous binder even if the aqueous binder is used. The present disclosure is characterized by using TGC as an aqueous binder for a battery electrode.

In an embodiment of the present disclosure, when the above-described TGC is dispersed in water that is a solvent, tragacanthin or tragacanthic acid, which is a water-soluble moiety, is dissolved to be able to form a viscous colloidal hydrosol, and insoluble Bassorin swells to be able to form a gel. Further, 3 to 4% of the protein contained in TGC may be helpful in making a uniform slurry by acting as an emulsifier.

Specifically, Bassorin may bind insoluble particles such as an electrode active material or a conductive material, and the above-described protein content may reduce the interfacial resistance between adjacent particles. As a result, TGC may be used as a binder for a battery electrode using such characteristics.

In an embodiment of the present disclosure, the battery may be a secondary battery, and further, the secondary battery may be any one of a zinc air battery, a lithium air battery, a lithium sulfur battery, a lead acid battery, a nickel hydride battery, a nickel cadmium battery, a sodium-ion battery, and a lithium-ion battery, for example, a lithium-ion battery.

An aspect of the present disclosure provides an active material slurry composition for a battery electrode, the active material slurry composition including: an electrode active material; an aqueous binder composed of tragacanth gum (TGC); and a solvent composed of water (H₂O).

In an embodiment of the present disclosure, the battery may be a secondary battery, and further, the secondary battery may be any one of a zinc air battery, a lithium air battery, a lithium sulfur battery, a lead acid battery, a nickel hydride battery, a nickel cadmium battery, a sodium-ion battery, and a lithium-ion battery, for example, a lithium-ion battery.

Hereinafter, for convenience of description, a case in which the battery is used in a lithium-ion battery will be described as an example. However, the contents described in the following aspects may be applied in the same manner except for the configuration that is varied by the properties of the electrode configuration of a battery other than the lithium-ion battery.

In general, an electrode of a battery includes an anode and a cathode, and the anode and the cathode each include a current collector and an active material layer positioned on the surface of the current collector. The active material layer is formed by coating an active material slurry composition including an electrode active material, a conductive material, and a binder, and the binder serves to assist bonding of the current collector and the active material layer.

Stabilization and dispersion of the electrode active material and the conductive material contained in the active material slurry composition of the battery affect the electrochemical properties such as capacity, rate performance, cycle performance, and electronic and ionic conductivity of a battery manufactured using the active material slurry composition.

The active material slurry composition for the battery electrode of the present disclosure includes an electrode active material.

In an embodiment of the present disclosure, the electrode active material may mean a material involved in the electrode reaction of a battery, for example, a lithium-ion battery, and the electrode active material may be a cathode active material for a lithium-ion battery or an anode active material for a lithium-ion battery.

In an embodiment of the present disclosure, when the electrode active material is a cathode active material for a lithium-ion battery, the electrode active material may be used without limitation as long as it is a compound capable of causing a reversible reaction of lithium.

For example, the electrode active material may include one or more selected from the group consisting of lithium nickel cobalt aluminum oxide (NCA), lithium nickel cobalt manganese oxide (NCM), lithium iron phosphate (LFP), lithium manganese oxide (LMO), and lithium cobalt oxide (LCO), for example, one or more selected from the group consisting of LMO having a spinel structure, NCA having a layered structure, and LFP having an olivine structure.

In another embodiment of the present disclosure, when the electrode active material is an anode active material for a lithium-ion battery, the electrode active material may be used without limitation as long as it is a material capable of causing a reversible reaction with lithium ions. For example, crystalline carbon, amorphous carbon, or both thereof may be used as the electrode active material.

Next, the active material slurry composition for the battery electrode of the present disclosure includes: an aqueous binder composed of tragacanth gum (TGC); and a solvent composed of water (H₂O).

The description of the aqueous binder composed of TGC is replaced with that described in the above aspect.

In an embodiment of the present disclosure, the ratio of the electrode active material and the aqueous binder may vary depending on the type of the electrode active material in order to obtain electrochemical properties of the battery.

As a specific example, when the electrode active material is any one of LMO having a spinel structure, NCA having a layered structure, and LFP having an olivine structure, the aqueous binder and the electrode active material may be contained at a ratio of 1:14 to 1:18, for example, 1:16.

In an embodiment of the present disclosure, when the ratio of the aqueous binder to the electrode active material is less than 1:14, the internal resistance of the electrode active material layer of the battery may increase, and when it exceeds 1:18, the adhesion between the active material layer and a current collector is not obtained so that the electrode of the battery may become unstable, and the charge/discharge cycle characteristics deteriorate so that sufficient electrochemical properties may not be obtained.

The active material slurry composition for the battery electrode of the present disclosure includes a solvent composed of water (H₂O).

In an embodiment of the present disclosure, the solvent is a factor that determines the viscosity of the active material slurry composition produced according to the composition of an active material slurry composition, and the solvent may be selected and contained in an appropriate amount.

The active material slurry composition for the battery electrode of the present disclosure may further include a conductive material.

The conductive material is for improving the conductivity of the active material slurry composition, and may include, for example, any one or more of conductive materials consisting of natural graphite, artificial graphite, carbon black, acetylene black (Denka black), Ketjen black, channel black, furnace black, lamp black, summer black, carbon fiber, metal fiber, carbon fluoride, aluminum powder, nickel powder, zinc oxide, potassium titanate, titanium oxide, polyphenylene derivatives, and combinations thereof, but the present disclosure is not limited thereto.

The ratio of the conductive material and the aqueous binder may vary depending on the type of the conductive material in order to obtain electrochemical properties of the battery.

As a specific example, when the conductive material is acetylene black (Denka black), the conductive material and the aqueous binder may be contained at a ratio of 2:1 to 4:1, for example, 3:1.

An aspect of the present disclosure provides a method for manufacturing a battery electrode, the method including the steps of: preparing an active material slurry composition by mixing an electrode active material, an aqueous binder composed of tragacanth gum (TGC), and water (H₂O) (step 1); and forming an active material layer by applying the active material slurry composition to the surface of a current collector and drying the active material slurry composition (step 2).

First, the method for manufacturing the battery electrode of the present disclosure includes the step (step 1) of preparing an active material slurry composition by mixing an electrode active material, an aqueous binder composed of tragacanth gum (TGC), and water (H₂O).

In an embodiment of the present disclosure, the active material slurry composition may further include a conductive material in the step 1.

In an embodiment of the present disclosure, the active material slurry composition may be the active material slurry composition for the battery electrode described in the above aspect. Accordingly, the description of the electrode active material, the aqueous binder, and the conductive material is replaced with that described in the above aspect.

In an embodiment of the present disclosure, the step 1 may be performed by mixing the electrode active material, the aqueous binder, and the conductive material at a predetermined ratio.

The ratio of the electrode active material, the aqueous binder, and the conductive material may vary depending on the type of the electrode active material and the conductive material in order to obtain electrochemical properties of the battery.

As a specific example, when the electrode active material is any one of LMO having a spinel structure, NCA having a layered structure, and LFP having an olivine structure, and the conductive material is acetylene black (Denka black), the electrode active material, the conductive material, and the aqueous binder may be mixed at a ratio of 14:5:1 to 18:1:1, for example, 16:3:1.

Next, the method for manufacturing the battery electrode of the present disclosure includes the step (step 2) of forming an active material layer by applying the active material slurry composition to the surface of a current collector and drying the active material slurry composition.

In an embodiment of the present disclosure, the current collector used in the step 2 serves to support the electrode, and the type of the current collector is not particularly limited as long as it has conductivity without causing chemical change of the battery.

For example, when the current collector is a current collector used for an anode, it may include a metal foil, an etching metal foil, an expanded metal, etc. that are called copper and nickel, and when the current collector is used for a cathode, it may include a metal material such as aluminum, copper, nickel, tantalum, stainless steel, titanium, etc., for example, aluminum, and may be appropriately selected and used depending on the type of a battery to be manufactured.

In an embodiment of the present disclosure, the step 2 may be performed by applying the active material slurry composition to one or both surfaces of the above-described current collector, and drying the active material slurry composition.

The step of forming the active material layer may be performed using any one method of a doctor blade method, a dip method, a reverse roll method, a direct roll method, a gravure method, an extrusion method, and a brush application method, but the present disclosure is not limited thereto. The active material slurry composition applied to the current collector may be dried at 20 to 250° C., for example, 50 to 150° C., for example, 80° C. for 1 minute to 8 hours, for example, 5 minutes to 7 hours, for example, 5 hours, but the present disclosure is not limited thereto.

An aspect of the present disclosure provides a battery electrode including an aqueous binder for a battery electrode, composed of tragacanth gum (TGC), of the above-described aspect, and a lithium-ion battery including the battery electrode.

The description of the configuration of the lithium-ion battery is self-evident in the present technical field, and a description thereof will be omitted.

The aqueous binder for the battery electrode, composed of tragacanth gum, of the present disclosure may use environmentally friendly water (H₂O) as a solvent instead of a conventional non-aqueous solvent that is expensive and harmful to the environment so that it is possible to provide a battery electrode manufactured by an environmentally friendly and economical method.

Furthermore, a battery manufactured using the aqueous binder composed of tragacanth gum, for example, a lithium-ion battery has an effect that it can provide a lithium-ion battery sufficient to replace a lithium-ion battery manufactured using a conventional PVdF-based binder.

Hereinafter, the present disclosure will be described in more detail with reference to the following examples. However, the following examples only illustrate the present disclosure, and the content of the present disclosure is not limited by the following examples.

### EXAMPLE

### Example 1. Manufacturing of Lithium-Ion Battery Cathode

A uniform active material slurry composition was prepared by mixing spinel LiMn₂O₄ (hereinafter, LMO) as a cathode active material; Denka Black as a conductive material; and tragacanth gum (Sigma-Aldrich; hereinafter, TGC) as a binder at a weight ratio of 80:15:5 respectively, and adding an appropriate amount of distilled water as a solvent.

A dried electrode was manufactured by uniformly applying the active material slurry composition to an aluminum foil by a doctor blade method to dry the active material slurry composition at room temperature overnight, and drying it in a convection oven at 80° C. for 5 hours.

A lithium-ion battery cathode was manufactured by compressing and punching the dried electrode with a roll press machine to form a 14 mm-sized circular disk, and redrying it in a vacuum oven at 80° C. for 3 hours.

### Comparative Example 1. Manufacturing of Lithium-Ion Battery Cathode

A lithium-ion battery cathode was manufactured by performing the process in the same manner as in Example 1 except that polyvinylidene fluoride (hereinafter, PVdF) was used as a binder instead of TGC, and N-methyl-2-pyrrolidone (hereinafter, NMP) was used as a solvent instead of distilled water in Example 1.

### Example 2. Manufacturing of Lithium-Ion Battery Cathode

A uniform active material slurry composition was prepared by mixing stacked LiNi_{0.8}Co_{0.15}Al_{0.05}O₂ (hereinafter, NCA) as a cathode active material; Denka Black as a conductive material; and tragacanth gum (Sigma-Aldrich; hereinafter, TGC) as a binder at a weight ratio of 80:15:5 respectively, and adding an appropriate amount of distilled water as a solvent.

A dried electrode was manufactured by uniformly coating the active material slurry composition on an aluminum foil by a doctor blade method to dry the active material slurry composition at room temperature overnight, and drying it in a convection oven at 80° C. for 5 hours.

A lithium-ion battery cathode was manufactured by compressing and punching the dried electrode with a roll press machine to form a 14 mm-sized circular disk, and redrying it in a vacuum oven at 80° C. for 3 hours.

### Comparative Example 2. Manufacturing of Lithium-Ion Battery Cathode

A lithium-ion battery cathode was manufactured by performing the process in the same manner as in Example 2 except that PVdF was used as a binder instead of TGC, and NMP was used as a solvent instead of distilled water in Example 2.

### Example 3. Manufacturing of Lithium-Ion Battery Cathode

A uniform active material slurry composition was prepared by mixing olivine LiFePO₄ (hereinafter, LFP) as a cathode active material; Denka Black as a conductive material; and tragacanth gum (Sigma-Aldrich; hereinafter, TGC) as a binder at a weight ratio of 80:15:5 respectively, and adding an appropriate amount of distilled water as a solvent.

A dried electrode was manufactured by uniformly coating the active material slurry composition on an aluminum foil by a doctor blade method to dry the active material slurry composition at room temperature overnight, and drying it in a convection oven at 80° C. for 5 hours.

A lithium-ion battery cathode was manufactured by compressing and punching the dried electrode with a roll press machine to form a 14 mm-sized circular disk, and redrying it in a vacuum oven at 80° C. for 3 hours.

### Comparative Example 3. Manufacturing of Lithium-Ion Battery Cathode

A lithium-ion battery cathode was manufactured by performing the process in the same manner as in Example 3 except that PVdF was used as a binder instead of TGC, and NMP was used as a solvent instead of distilled water in Example 3.

### Experimental Example 1. Checking XRD Patterns

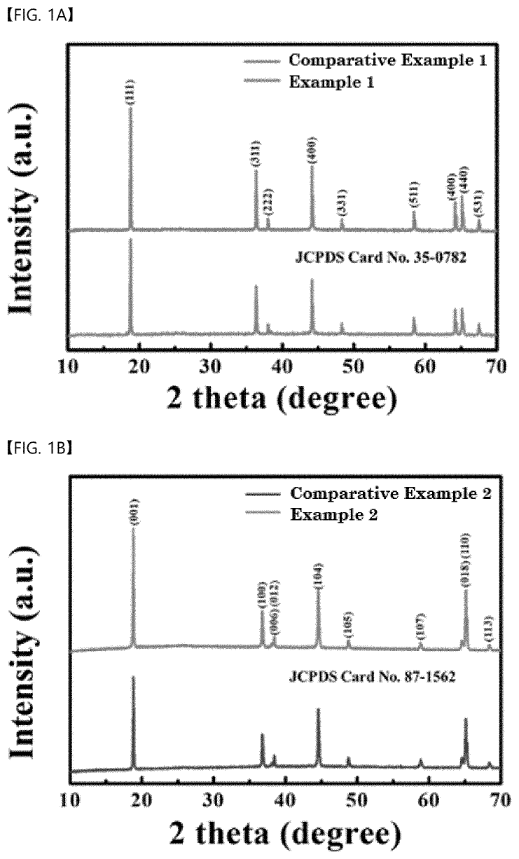

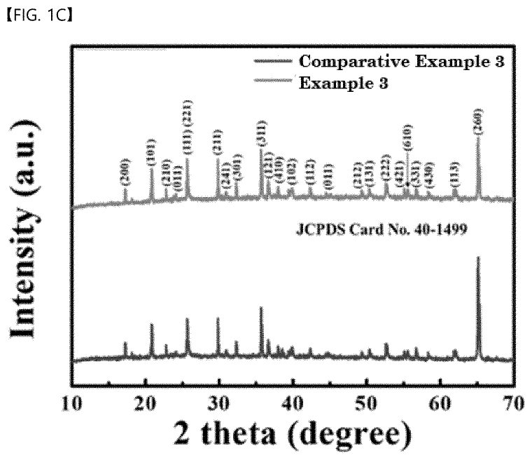

In order to confirm the crystallinity of the lithium-ion battery cathodes manufactured in Examples 1 to 3 and Comparative Examples 1 to 3, after checking XRD patterns in a 2θ range of 10° to 70° using an X-ray diffractometer (XRD, M18XHF-SRA, Mac Science Ltd.), the results are shown in FIGS. 1A to 1C.

Specifically, FIG. 1A is the XRD pattern results of Example 1 and Comparative Example 1, FIG. 1B is the XRD pattern results of Example 2 and Comparative Example 2, and FIG. 1C is the XRD pattern results of Example 3 and Comparative Example 3.

Referring to FIG. 1A, it could be confirmed that all the diffraction peaks were well indexed on the (111), (311), (400) and (440) planes of the spinel LMO (JCPDS card number 35-0782).

Referring to FIG. 1B, it could be confirmed that characteristic peaks were shown at 18.8°, 36.7°, 38.2°, 38.5°, 44.5°, 48.7°, 58.8°, 64.6°, and 65.1° of the stacked NCA (JCPDS card number 87-1562) in both Example 2 and Comparative Example 2, and it could be confirmed that the characteristic peaks were each indexed on the (003), (101), (006), (102), (104), (105), (107), (018), and (110) planes.

Referring to FIG. 1C, it could be confirmed that specific peaks were shown at 17.90°, 23.90°, 25.57°, and 31.94° of olivine LFP (JCPDS card number 40-1499), and were each indexed on the (121), (210), (221), and (241) planes.

As a result, referring to FIGS. 1A to 1C, it could be confirmed that the binder and the solvent did not affect the crystallinity of the cathode active material.

### Experimental Example 2. Checking Viscosities of Active Material Slurry Compositions

Rheologies of the active material slurry compositions of Examples 1 to 3 and Comparative Examples 1 to 3 were measured using a stress control rheometer (Haake Mars, Thermo Electron GmbH). Viscosities of the active material slurry compositions were measured at a shear rate of 0 s⁻¹ to 200 s⁻¹, and before the analysis, the samples were equilibrated at 25° C. to confirm that the rheologies were stable, and then the samples were pre-sheared three times in the same shear rate range.

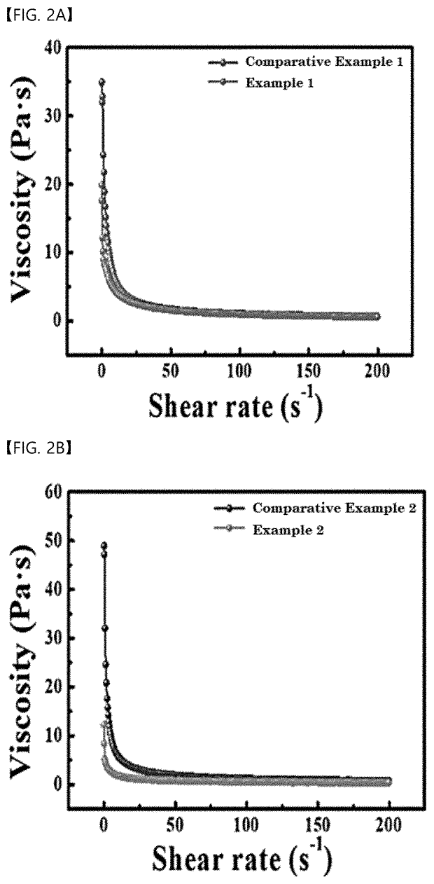

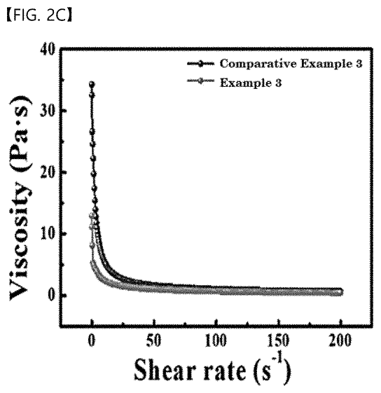

After measuring rheologies of the active material slurry compositions, viscosity values of the active material slurry compositions of Examples 1 to 3 and Comparative Examples 1 to 3 are shown in Table 1, and the viscosity values depending on the shear rates are shown in FIGS. 2A to 2C:

TABLE 1

| Cathode | | | | | | | |
|---|---|---|---|---|---|---|---|
| active | | | | | | | |
| material | LMO | | NCA | | LFP | | Binder |
| Viscosity | Example 1 | 0.61 | Example 2 | 0.40 | Example 3 | 0.48 | TGC |
| (Pa · s) | Comparative | 0.66 | Comparative | 0.70 | Comparative | 0.63 | PVdF |
| | Example 1 | | Example 2 | | Example 3 | | |

Specifically, FIG. 2A is a graph showing the viscosities of the active material slurry compositions of Example 1 and Comparative Example 1, FIG. 2B is a graph showing the viscosities of the active material slurry compositions of Example 2 and Comparative Example 2, and FIG. 2C is a graph showing the viscosities of the active material slurry compositions of Example 3 and Comparative Example 3.

Referring to Table 1 and FIGS. 2A to 2C, the active material slurry compositions of Comparative Example 1, Comparative Example 2, and Comparative Example 3 have viscosities of 0.66 Pa·s, 0.70 Pa·s, and 0.63 Pa·s respectively, and it can be confirmed that when compared with respective viscosities of the active material slurry compositions of Examples 1 to 3 of 0.61 Pa·s, 0.40 Pa·s, and 0.48 Pa·s, the viscosities of the active material slurry compositions of Comparative Examples 1 to 3 are slightly higher than the viscosities of the active material slurry compositions of Examples 1 to 3.

Referring to FIGS. 2A to 2C, although it can be confirmed that the viscosities of the active material slurry compositions each decrease when the shear rates are high, it can be seen that the active material slurry compositions of Examples 1 to 3 each show lower viscosities at high shear rates compared to the active material slurry compositions of Comparative Examples 1 to 3, and it can be seen that the low viscosities of the active material slurry compositions are more suitable for performing uniform coating by the doctor blade method.

### Experimental Example 3. Checking Surface Morphologies

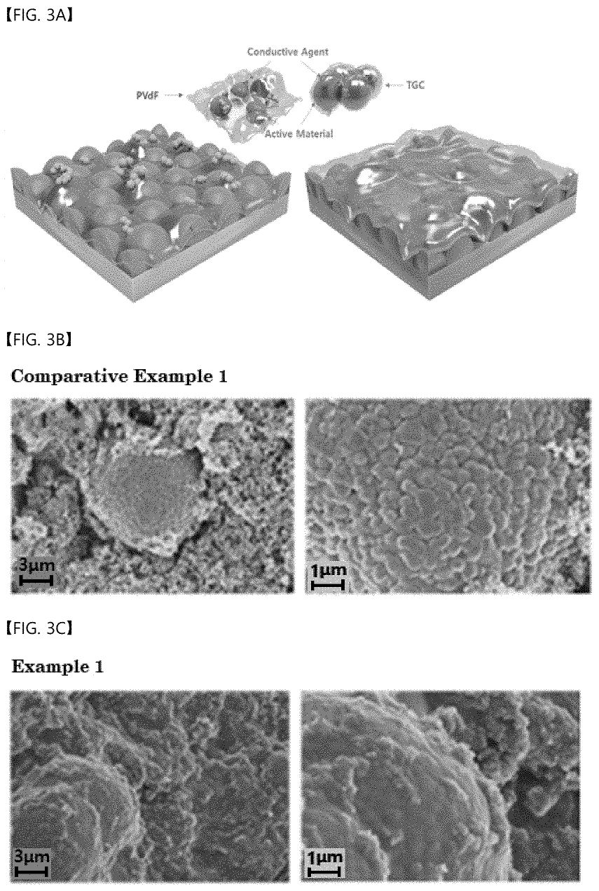

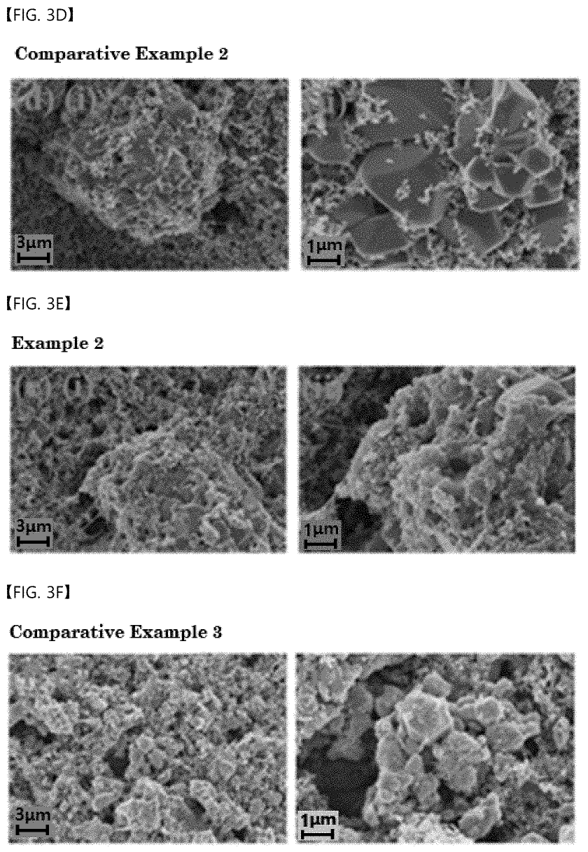

After measuring surface morphologies of the lithium-ion battery cathodes manufactured in Examples 1 to 3 and Comparative Examples 1 to 3 at various magnifications using a field emission-scanning electron microscope (FE-SEM, Carl Zeiss, LEO SUPRA 55), the results are shown in FIGS. 3A to 3G.

Specifically, FIG. 3A is a schematic diagram showing interactions of a binder, a cathode active material, and a conductive material on the surface of a lithium-ion battery cathode, and FIGS. 3B to 3G are FE-SEM images of the surfaces of the lithium-ion battery cathodes manufactured in Examples 1 to 3 and Comparative Examples 1 to 3.

Referring to FIGS. 3A to 3G, it can be confirmed that the surface shapes of the lithium-ion battery cathodes in the case of Comparative Examples 1 to 3 are consistent with the surface shape reported in the prior literature of the lithium-ion battery cathode manufactured using PVdF as a binder and using NMP as a solvent, whereas in the case of Examples 1 to 3, the TGC binder forms a layer covering the cathode active material of the lithium-ion battery cathode and the Denka black particles.

The layer formed by the TGC binder can be expected to increase electrical conductivity and improve electrochemical performance by reducing the resistance between adjacent cathode active material particles.

### Experimental Example 4. Checking Electrochemical Properties

Manufacturing of Half-Cells

The lithium-ion battery cathodes manufactured in Examples 1 to 3 and Comparative Examples 1 to 3 were used as working electrodes, a lithium foil was used as a counter electrode, a polypropylene/polyethylene/polypropylene (PP/PE/PP) porous triple layer was used as a separator, 1 M LiPF₆ (in EC/DEC ratio 1:1 (v/v)) was used as an electrolyte, and electrochemical half-cells (CR 2032 coin-type batteries) were assembled and manufactured in a glove box filled with argon.

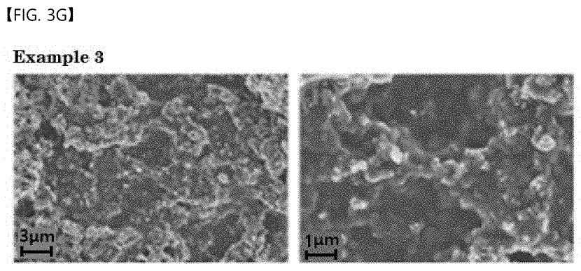

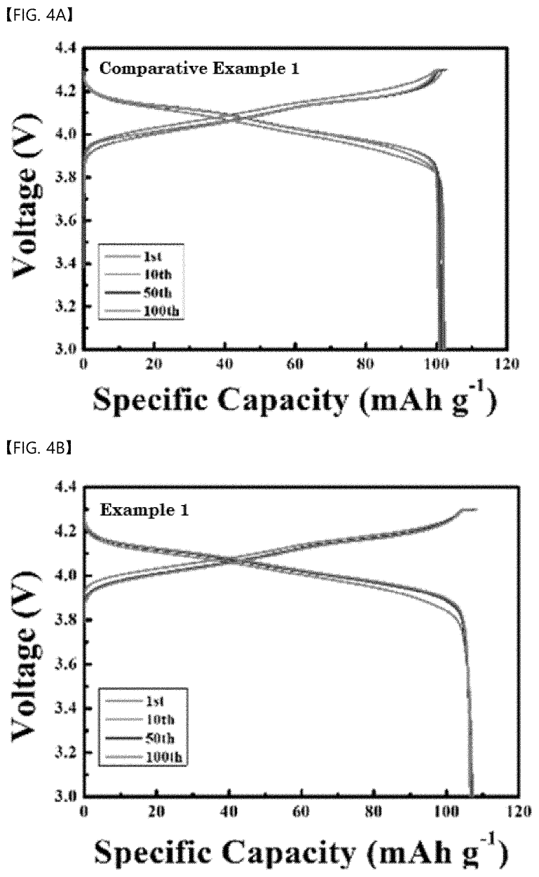

After checking the electrochemical properties using the electrochemical half-cells manufactured using the lithium-ion battery cathodes manufactured in Examples 1 to 3 and Comparative Examples 1 to 3, the results are shown in FIGS. 4A, 4B, 5A, 5B, 6A, 6B, 7A, 7B, 8A, 8B, 9A, 9B, 10A, 10B, 11A, 11B, 12A, and 12B.

### i) Example 1 and Comparative Example 1 (Lithium-Ion Battery Cathodes Using LMO as Cathode Active Material)

FIGS. 4A and 4B are charge/discharge profiles of Example 1 and Comparative Example 1.

Referring to FIGS. 4A and 4B, it could be confirmed that Comparative Example 1 provided specific charge/discharge capacities of 102.7/102.2 mAh g⁻¹ in the first cycle, whereas Example 1 delivered 108.2/107.2 mAh g⁻¹ in the first cycle, thereby providing higher charge/discharge capacities than Comparative Example 1.

FIG. 5A is a graph showing the lifespan characteristics of up to 100 cycles of Example 1 and Comparative Example 1 at 0.2 C.

Referring to FIG. 5A, it could be confirmed that better performance was maintained up to the 100th cycle with specific charge and discharge capacities of 106.8/106.6 mAh g⁻¹ and a capacity retention rate of 99.4% in the case of Example 1, and it could be confirmed that the lithium-ion battery cathodes of Comparative Example 1 and Example 1 had coulombic efficiencies of 99.5% and 99.3% in the first cycle, and maintained coulombic efficiencies of 99.5% and 99.8% respectively in the 100th cycle.

FIG. 5B is a graph showing rate performances of the lithium-ion battery cathodes of Example 1 and Comparative Example 1. At this time, the charge/discharge test was performed at various C-rates ranging from 0.2 C to 5 C, and returned to 0.2 C at room temperature.

Referring to FIG. 5B, it could be confirmed that the specific discharge capacities of 107.0, 106.3, 105.4, 103.4, 96.8, and 106.0 mAh g⁻¹ were respectively delivered by the lithium-ion battery cathode of Example 1 at 0.2, 0.5, 1.0, 2.0, 5.0, and 0.2 C, but specific discharge capacities of 102.2, 101.5, 100.7, 98.8, 92.9, and 101.2 mAh g⁻¹ were delivered by the lithium-ion battery cathode of Comparative Example 1 at the same C-rate.

The rate performance was calculated by dividing the percentage of a discharge capacity maintained at the high C-rate “5 C” by the capacity at the low C-rate “0.2 C”, and according to the above calculation, Comparative Example 1 had a rate performance of 90.9% and Example 1 had a rate performance of 90.5% so that it could be confirmed that the rate performances were 90% or more in both Example 1 and Comparative Example 1.

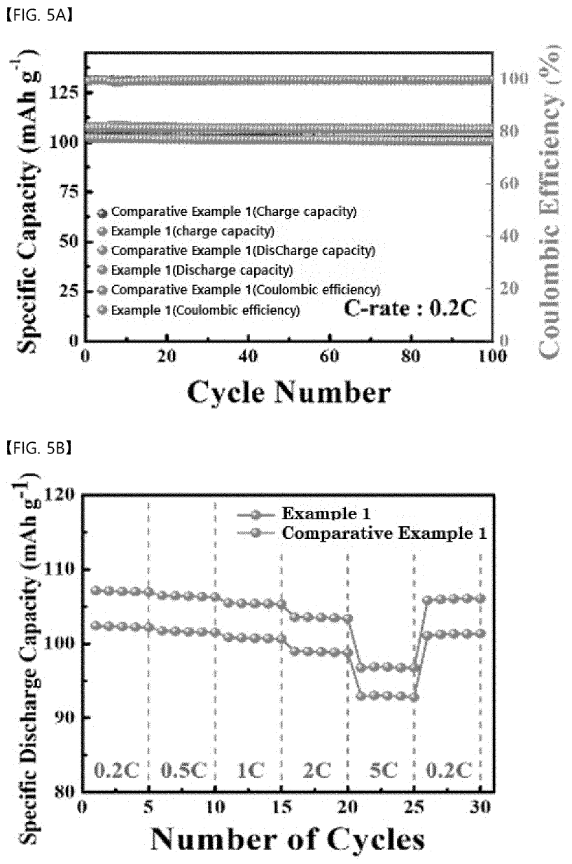

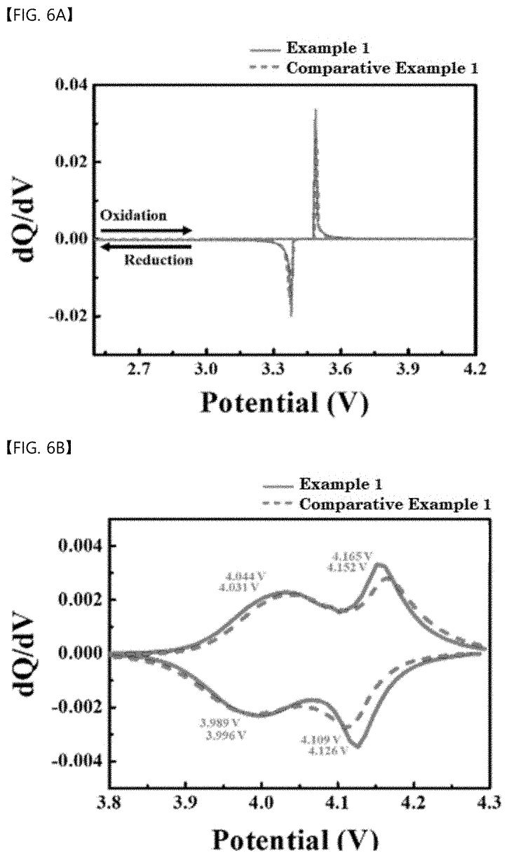

FIGS. 6A and 6B are a graph showing differential capacity profiles with respect to voltages in a potential range of 3.0 V to 4.3 V of the lithium-ion battery cathodes manufactured in Example 1 and Comparative Example 1 during the fourth cycle.

Referring to FIGS. 6A and 6B, it could be confirmed that the lithium-ion battery cathode of Comparative Example 1 showed two oxidation peaks at 4.044 V and 4.165 V, and the corresponding reduction peaks at 3.989 V and 4.109 V, whereas the lithium-ion battery cathode of Example 1 showed two oxidation peaks at 4.031 V and 4.152 V, and the corresponding reduction peaks at 3.996 V and 4.126 V.

As a result, potential differences (Δ) between the corresponding peaks were 0.055 V and 0.056 V in the case of Comparative Example 1, whereas the potential differences were 0.035 V and 0.026 V in the case of Example 1 so that it could be confirmed that the potential differences were low. Due to low Δ, i.e., low voltage polarization of the material, it can be expected that the conductivities are improved and affect the ability to break the kinetics of lithium intercalation/deintercalation at the electrode/electrolyte interface and the kinetic barrier of the electrochemical redox reaction, thereby enabling the electrochemical reversibility and reactivity to be improved.

### ii) Example 2 and Comparative Example 2 (Lithium-Ion Battery Cathodes Using NCA as Cathode Active Material)

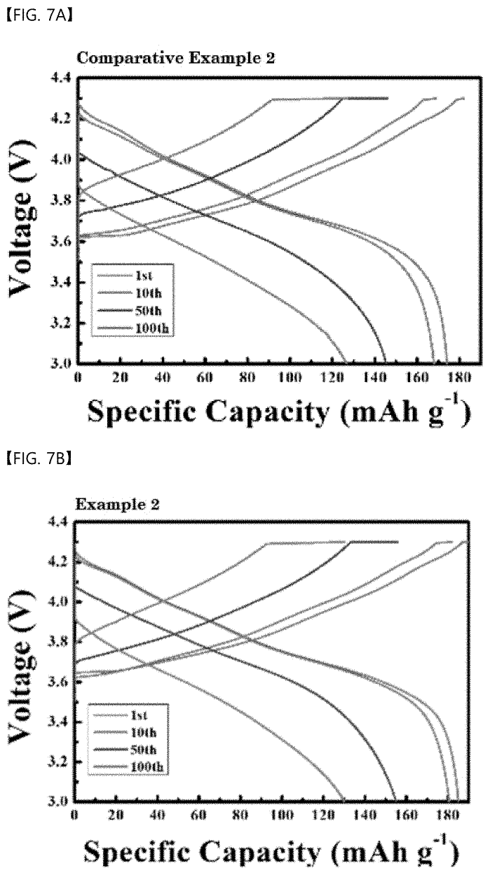

FIGS. 7A and 7B are charge/discharge profiles of the lithium-ion battery cathodes manufactured in Example 2 and Comparative Example 2.

Referring to FIGS. 7A and 7B, it could be confirmed that the lithium-ion battery cathode of Comparative Example 2 provided specific charge/discharge capacities of 181.8/174.1 mAh g⁻¹ with respect to the first cycle and 127.0/126.7 mAh g⁻¹ with respect to the 100th cycle, and the lithium-ion battery cathode of Example 2 showed charge/discharge capacities of 193.0/185.1 mAh g⁻¹ in the first cycle and 130.3/130.2 mAh g⁻¹ in the 100th cycle, and it could be confirmed that the lithium-ion battery cathode of Example 2 achieved higher capacities than the lithium-ion battery cathode of Comparative Example 2.

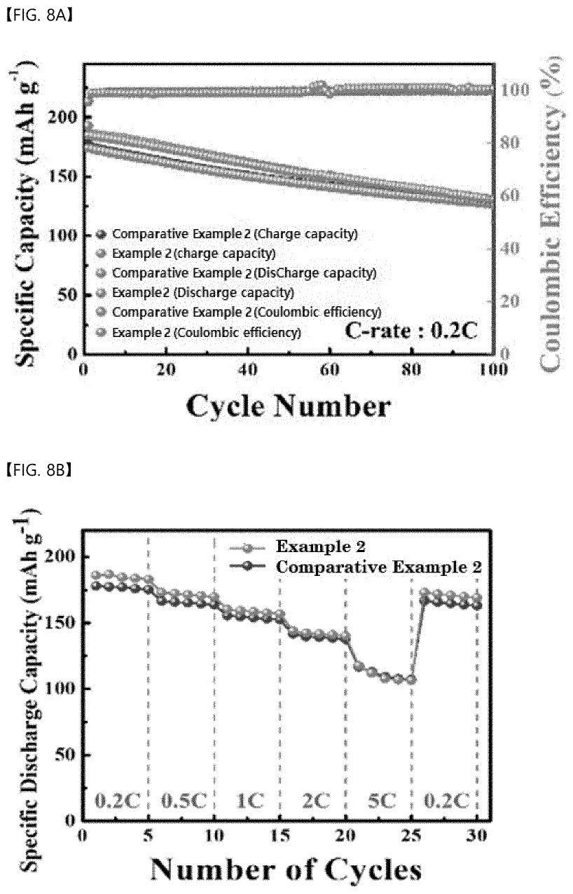

FIG. 8A is a graph showing the lifespan characteristics of Example 2 and Comparative Example 2.

Referring to FIG. 8A, the lithium-ion battery cathodes of Comparative Example 2 and Example 2 had capacity retention rates of 72.7% and 70.3% respectively, and coulombic efficiencies of 95.7% and 95.7% respectively in the first cycle and 99.8% and 100.5% respectively in the 100th cycle. It could be confirmed that the lithium-ion battery cathodes of Comparative Example 2 and Example 2 exhibited similar lifespan characteristics and coulombic efficiencies until the 100th cycle.

FIG. 8B is a graph showing rate performances of the lithium-ion battery cathodes of Example 2 and Comparative Example 2. At this time, the charge/discharge test was performed at various C-rates ranging from 0.2 C to 5 C, and returned to 0.2 C at room temperature.

Referring to FIG. 8B, the lithium-ion battery cathode of Comparative Example 2 provided specific discharge capacities of 177.1, 165.1, 153.9, 139.1, and 109.4 mAh g⁻¹ at C-rates of 0.2, 0.5, 1.0, 2.0, and 5.0 C respectively, and the electrodes could maintain a specific discharge capacity of 164.7 mAh g−1 when the current rate returned to 0.2 C. The lithium-ion battery cathode of Example 1 provided specific discharge capacities of 184.4, 171.4, 158.4, 141.7, 107.8, and 170.9 mAh g⁻¹ at C-rates of 0.2, 0.5, 1.0, 2.0, 5.0, and 0.2 C.

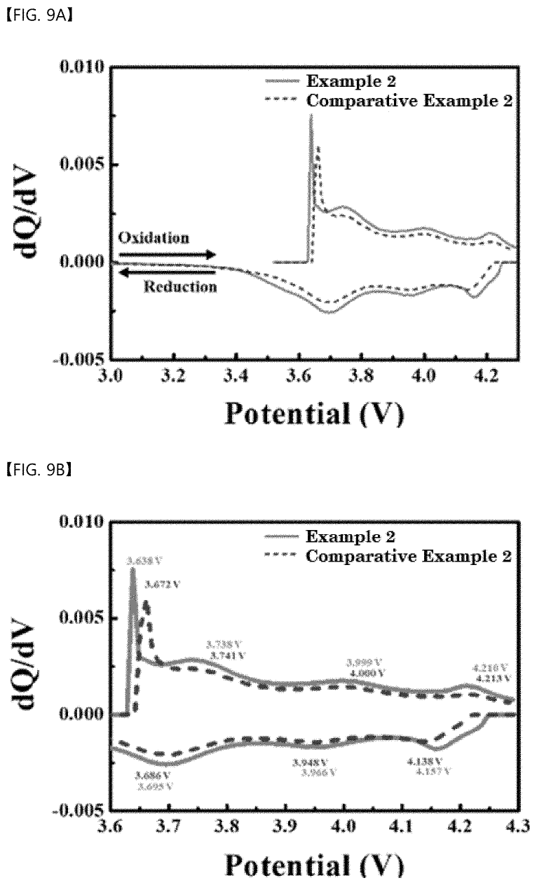

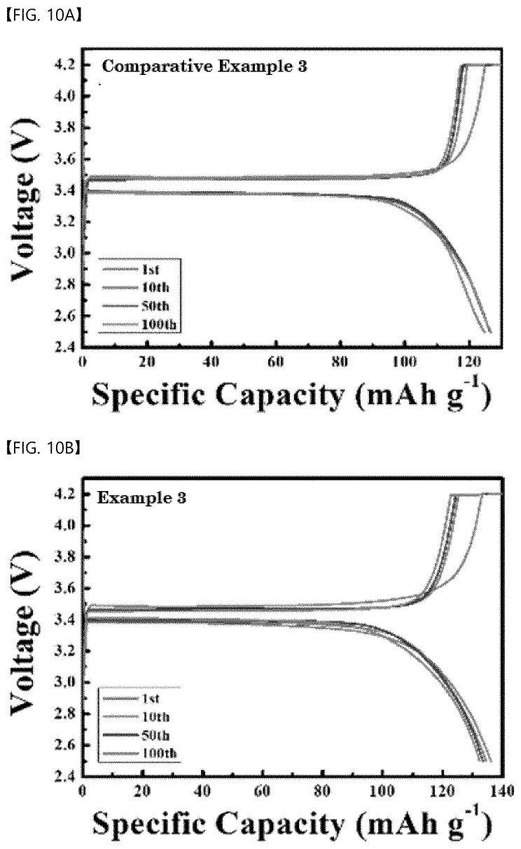

FIGS. 9A and 9B are graphs showing differential capacity profiles with respect to voltages in a potential range of 3.0 V to 4.3 V of the lithium-ion battery cathodes manufactured in Example 2 and Comparative Example 2 during the fourth cycle.

Referring to FIGS. 9A and 9B, it could be confirmed that the lithium-ion battery cathode of Comparative Example 2 had oxidation peaks at 3.672 V to 3.741 V, 4.000 V, and 4.213 V, and had corresponding reduction peaks at 3.686 V, 3.948 V, and 4.138 V, whereas the lithium-ion battery cathode of Example 2 had oxidation peaks at 3.638 V to 3.738 V, and 3.999 V, and had corresponding reduction peaks at 3.695 V, 3.966 V, and 4.157 V. As a result, it could be confirmed that the lithium-ion battery cathode of Comparative Example 2 had potential differences (Δ) between the corresponding peaks of 0.055 V, 0.052 V, and 0.075 V, and the lithium-ion battery cathode of Example 2 had potential differences (Δ) between the corresponding peaks of 0.043 V, 0.033 V, and 0.053 V.

### iii) Example 3 and Comparative Example 3 (Lithium-Ion Battery Cathodes Using LFP as Cathode Active Material)

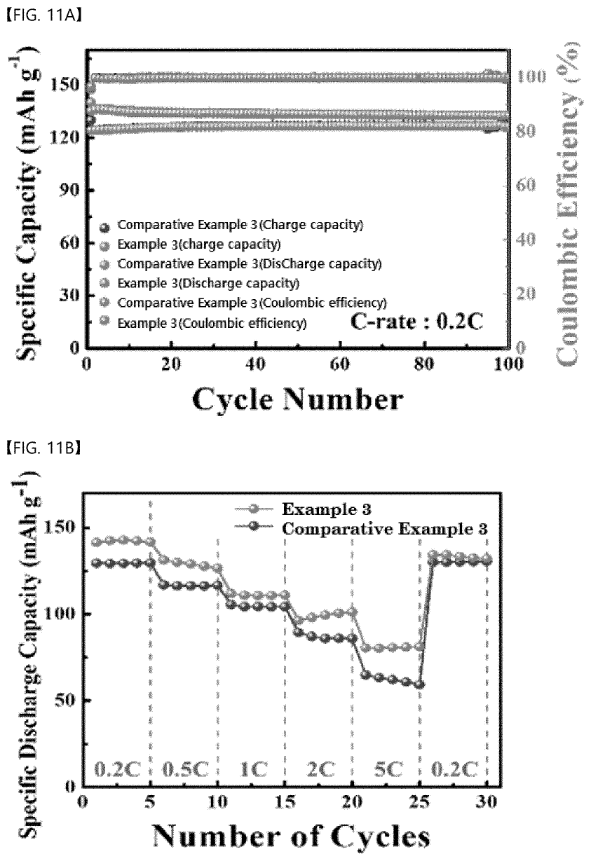

FIGS. 10A and 10B are charge/discharge profiles of the lithium-ion battery cathodes manufactured in Example 3 and Comparative Example 3.

Referring to FIGS. 10A and 10B, it could be confirmed that the lithium-ion battery cathode of Comparative Example 3 showed specific charge/discharge capacities of 130.0/124.6 mAh g⁻¹ in the first cycle and 124.9/126.4 mAh g⁻¹ in the 100th cycle, whereas the lithium-ion battery cathode of Example 3 provided specific charge/discharge capacities of 140.1/136.1 mAh g⁻¹ in the first cycle and 134.2/132.4 mAh g⁻¹ in the 100th cycle, and it could be confirmed that higher capacities were achieved in the case of Example 3 than Comparative Example 3, and the lithium-ion battery cathodes of Comparative Example 3 and Example 3 had capacity retention rates of 101.7% and 97.8% respectively.

FIG. 11A is a graph showing the lifespan characteristics of Example 3 and Comparative Example 3.

Referring to FIG. 11A, it could be confirmed that the lithium-ion battery cathodes of Comparative Example 3 and Example 3 had coulombic efficiencies of 95.6% and 96.6% respectively in the first cycle, and coulombic efficiencies after the 100th cycle of 99.7% and 99.8% respectively.

FIG. 11B is a graph showing rate performances of the lithium-ion battery cathodes of Example 3 and Comparative Example 3. At this time, the charge/discharge test was performed at various C-rates ranging from 0.2 C to 5 C, and returned to 0.2 C at room temperature.

Referring to FIG. 11B, it could be confirmed that the lithium-ion battery cathodes of Comparative Example 3 and Example 3 provided specific discharge capacities of 129.3, 116.3, 104.4, 86.0, 62.1, and 130.1 mAh g⁻¹, and 142.7, 129.0, 110.7, 99.6, 80.7, and 133.3 mAh g⁻¹ at C-rates of 0.2, 0.5, 1.0, 2.0, 5.0, and 0.2 C respectively, and it could be confirmed that the lithium-ion battery cathode of Comparative Example 3 had a rate performance of 48.0%, and the lithium-ion battery cathode of Example 3 had a rate performance of 56.6%.

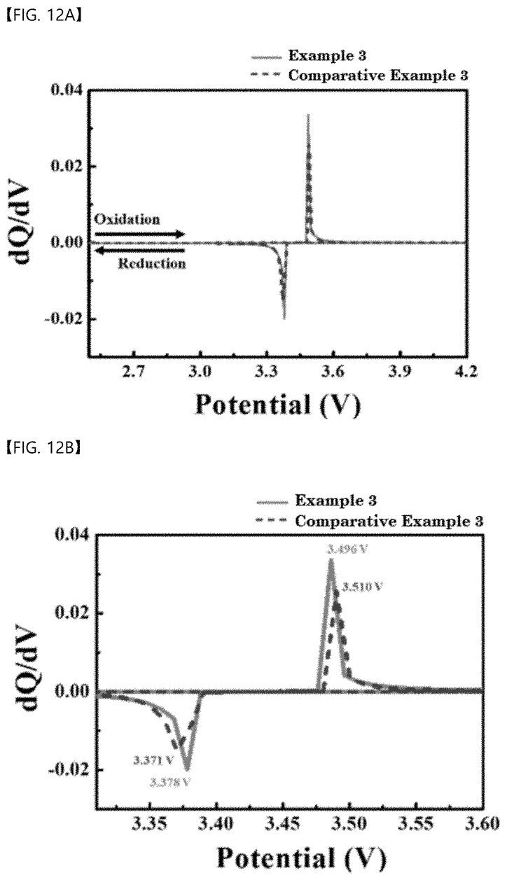

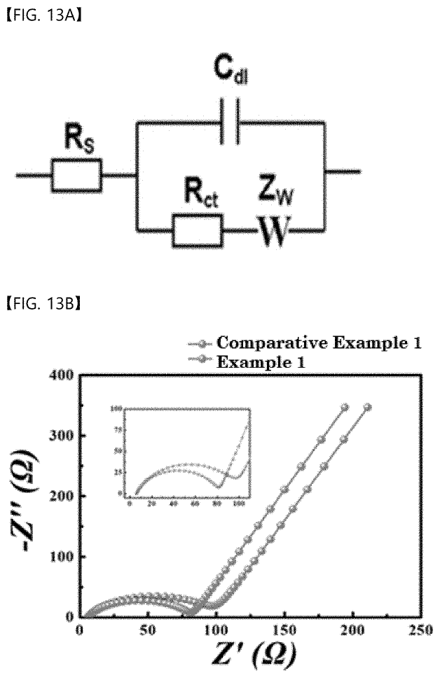

FIGS. 12A and 12B are graphs showing differential capacity profiles with respect to voltages in a potential range of 2.5 V to 4.2 V of the lithium-ion battery cathodes manufactured in Example 3 and Comparative Example 3 during the fourth cycle.

Referring to FIGS. 12A to 12B, it could be confirmed that the lithium-ion battery cathode of Comparative Example 3 had an oxidation peak at 3.510 V and a corresponding reduction peak at 3.371 V, whereas the lithium-ion battery cathode of Example 3 had an oxidation peak at 3.496 V and a corresponding reduction peak at 3.378 V, and it could be confirmed that Comparative Example 3 had a potential difference (Δ) of 0.139 V, whereas Example 3 had a potential difference (Δ) of 0.118 V.

### Experimental Example 5. Electrochemical Impedance Spectrum Measurement

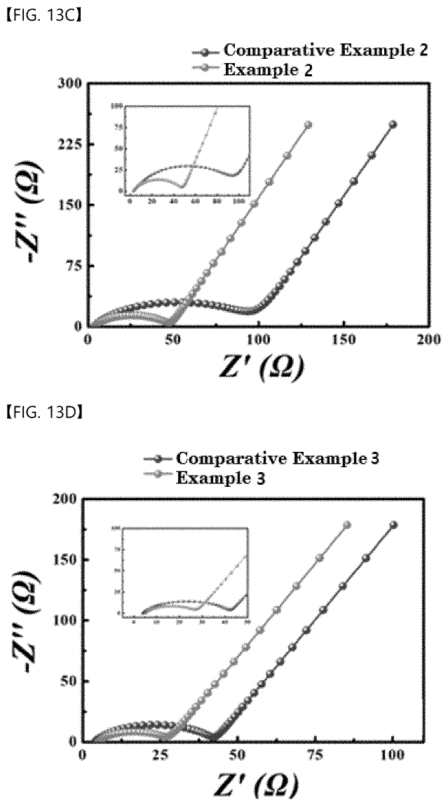

FIG. 13A is a diagram showing a Randles equivalent circuit, which is one of equivalent circuit models for EIS analysis of a lithium-ion battery, FIG. 13B is a Nyquist plot for the lithium-ion batteries of Example 1 and Comparative Example 1, FIG. 13C is a Nyquist plot for the lithium-ion batteries of Example 2 and Comparative Example 2, and FIG. 13D is a Nyquist plot for the lithium-ion batteries of Example 3 and Comparative Example 3.

Referring to FIGS. 13A to 13D, it could be seen that the Rct values of Example 1 and Comparative Example 1 were 76Ω and 91Ω (FIG. 13B) respectively, the Rct values of Example 2 and Comparative Example 2 were 44Ω and 89Ω (FIG. 13C) respectively, and the Rct values of Example 3 and Comparative Example 3 were 22Ω and 38Ω (FIG. 13D) respectively. It could be confirmed that lower Rct values were obtained in the case of Examples 1 to 3 than Comparative Examples 1 to 3. Through the reduced Rct values, the electrodes using the TGC binders of Examples 1 to 3 could be expected to have better compatibility with the electrolyte at the interface between the electrode and the electrolyte.

So far, the preferred embodiments have been examined with respect to the present disclosure. Those of ordinary skill in the art to which the present disclosure pertains will be able to understand that the present disclosure can be implemented in modified forms within a range that does not depart from the essential characteristics of the present disclosure. Therefore, the disclosed embodiments should be considered from an explanatory point of view rather than a limiting point of view. The scope of the present disclosure is indicated not in the foregoing description, but in particular in the scope of the claims, and all differences within the scope equivalent thereto should be construed as being included in the present disclosure.

What is claimed is:

1. An aqueous binder for a battery electrode, being composed of tragacanth gum (TGC).

2. The aqueous binder for the battery electrode of claim 1, wherein the battery is a secondary battery.

3. The aqueous binder for the battery electrode of claim 2, wherein the secondary battery is any one selected from the group consisting of a zinc air battery, a lithium air battery, a lithium sulfur battery, a lead acid battery, a nickel hydride battery, a nickel cadmium battery, a sodium-ion battery, and a lithium-ion battery.

4. An active material slurry composition for a battery electrode, comprising: an electrode active material; an aqueous binder composed of tragacanth gum (TGC); and a solvent composed of water (H₂O).

5. The active material slurry composition for the battery electrode of claim 4, wherein the battery is a secondary battery.

6. The active material slurry composition for the battery electrode of claim 5, wherein the secondary battery is any one selected from the group consisting of a zinc air battery, a lithium air battery, a lithium sulfur battery, a lead acid battery, a nickel hydride battery, a nickel cadmium battery, a sodium-ion battery, and a lithium-ion battery.

7. The active material slurry composition for the battery electrode of claim 4, wherein the electrode active material includes one or more selected from the group consisting of lithium nickel cobalt aluminum oxide (NCA), lithium nickel cobalt manganese oxide (NCM), lithium iron phosphate (LFP), lithium manganese oxide (LMO), and lithium cobalt oxide (LCO).

8. The active material slurry composition for the battery electrode of claim 7, wherein the electrode active material includes one or more selected from the group consisting of LMO having a spinel structure, NCA having a layered structure, and LFP having an olivine structure.

9. The active material slurry composition for the battery electrode of claim 4, wherein the aqueous binder and the electrode active material are contained at a ratio of 1:14 to 1:18.

10. The active material slurry composition for the battery electrode of claim 4, further comprising a conductive material.

11. The active material slurry composition for the battery electrode of claim 10, wherein the conductive material is one or more selected from the group consisting of natural graphite, artificial graphite, carbon black, acetylene black (Denka black), Ketjen black, channel black, furnace black, lamp black, summer black, carbon fiber, metal fiber, carbon fluoride, aluminum powder, nickel powder, zinc oxide, potassium titanate, titanium oxide, and polyphenylene derivatives.

12. The active material slurry composition for the battery electrode of claim 10, wherein the conductive material and the aqueous binder are contained at a ratio of 2:1 to 4:1.

13. A method for manufacturing a battery electrode, the method comprising steps of:
preparing an active material slurry composition by mixing an electrode active material, an aqueous binder composed of tragacanth gum (TGC), and water (H₂O) (step 1); and
forming an active material layer by applying the active material slurry composition to a surface of a current collector and drying the active material slurry composition (step 2).

14. The method of claim 13, wherein the active material slurry composition further includes a conductive material in the step 1.

15. The method of claim 13, wherein the step 2 is performed using any one method selected from the group consisting of a doctor blade method, a dip method, a reverse roll method, a direct roll method, a gravure method, an extrusion method, and a brush application method.

16. A battery electrode comprising the aqueous binder for the battery electrode of claim 1.

17. A lithium-ion battery comprising the battery electrode of claim 16.
